(19) United States
(12) Patent Application Publication
(10) Pub. No.: US 2020/0298411 A1
(43) Pub. Date: Sep. 24, 2020

(54) METHOD FOR THE ORIENTATION OF AN INDUSTRIAL ROBOT, AND INDUSTRIAL ROBOT

(71) Applicant: SIEMENS AKTIENGESELLSCHAFT, München (DE)

(72) Inventors: Wendelin Feiten, Neubiberg (DE); Kai Wurm, München (DE); Georg von Wichert, München (DE)

(21) Appl. No.: 16/305,641

(22) PCT Filed: May 22, 2017
(86) PCT No.: PCT/EP2017/062215

§ 371 Date: Nov. 29, 2018

(30) Foreign Application Priority Data
May 31, 2016 (DE) 102016209462.9
Jul. 12, 2016 (DE) 102016212694.6

(51) Int. Cl. B25J 9/16; B25J 13/08

(52) U.S. Cl. CPC B25J 9/1697; B25J 13/089; G05B 2219/39024; B25J 9/1664; B25J 9/1692; B25J 9/161

(57) ABSTRACT

Characteristics of surroundings are extracted from signals of sensors mounted on different of a stationary industrial robot and an absolute co-ordinate system and a map of the surroundings are determined simultaneously using a SLAM-algorithm for simultaneous localization and mapping, the map of the surroundings depicting the extracted characteristics and an absolute pose of a mobile part of the industrial robot being determined in the absolute co-ordinate system. The method transfers the technique of simultaneous localization and of establishing a map of characteristics of the surroundings, from the field of mobile robotics to the orientation of a stationary industrial robot. The method is based on the measurements of sensors attached to the mobile parts. Sensors which calculate the positions of the joints are also taken into consideration, and an absolute position and orientation is calculated even for imprecise or flexible industrial robots and for different loads.

### CROSS-REFERENCE TO RELATED APPLICATIONS

This application claims priority to PCT Application No. PCT/EP2017/062215, having a filing date of May 22, 2017, based off of German Application No. 10 2016 212 694.6 having a filing date of Jul. 12, 2016 and based off of German Application No. 10 2016 209 462.9 having a filing date of May 31, 2016, the entire contents both of which are hereby incorporated by reference.

### FIELD OF TECHNOLOGY

The following relates to a method for the orientation of an industrial robot, and industrial robot.

### BACKGROUND

Pursuant to VDI [Association of German Engineers] Guideline 2860, an industrial robot is a universally employable movement automaton having a plurality of axes, the movements of which are freely programmable and, where applicable, sensor guided. By way of example, such robots can be equipped with grippers or other tools as effectors and are able, as a result thereof, to carry out manipulation or manufacturing tasks. Consequently, industrial robots consist of a plurality of links, which connect a base to an effector and which are movable as per a kinematic system.

The prior art has disclosed the construction of an industrial robot as a robotic arm with a serial kinematic system, which consists of a plurality of main axes and wrists. The main axes predominantly serve the purpose of setting a position of the effector, which is mounted to a flange at the end of the robotic arm. By contrast, the wrists have the task of setting an orientation of the effector. While the main axes are selectively chosen as rotational axes or translational axes or as a combination of these two types, depending on the type of construction and usage purpose of the industrial robot, the wrists are always rotational axes.

Delta robots are a further example of industrial robots. These consist of a plurality of kinematic chains, which connect a base with an effector or work platform. By way of example, a delta robot consists of three arms, which together connect a work platform to a base. The mathematical description of the movement possibilities of a delta robot is a closed kinematic system in this case, for example a parallel kinematic system.

A problem arising in the case of such industrial robots is that the absolute position and orientation of the effector is not sufficiently well known in relation to a surroundings. This may also be the case if sensors are installed in the links of the industrial robot, said sensors being able to accurately determine the position of the latter.

There may be a number of reasons for this: the drives in the joints or the mechanical parts may be elastic, or the deflection may be unknown, for instance because it depends on an unknown load. Furthermore, the kinematic models, on account of which the position and orientation are calculated, may be_erroneous.

In conventional industrial robots, this is counteracted by way of designing these to be so solid that no elasticity occurs where possible, even in the case of a high load. Initially, this leads to high repetition accuracy. In order to obtain a high absolute accuracy, the industrial robot is displaced into different positions manually. The position of a link is measured accurately from the outside for each of these positions using a distance sensor, as disclosed in DE 10 2011 052 386 A1, for example. Within the scope of such a calibration, the relationship between the joint position and the position and orientation of the end effector is established and stored.

By way of example, the approach of assembling a camera on the end effector is known from S. Hutchinson, G. D. Hager, and P. I. Corke, “A tutorial on visual servo control”, IEEE Transactions on Robotics and Automation, vol. 12, no. 5, pp. 651-670, 1996. The camera is used to determine the relative position and orientation between a gripper and a work piece, or between two workpieces.

### SUMMARY

Below, the term “pose” also combines the position and orientation, for example of any link, feature or object.

Embodiments of the present invention are intended to develop a method for orienting an industrial robot and an industrial robot, which provide an alternative to the prior art.

An aspect relates to a method for orienting an industrial robot,
wherein at least one feature of a surroundings is extracted from signals of at least one imaging sensor, which is mounted on a movable part of a stationary industrial robot, before, while or after the industrial robot carries out movements, and
wherein a SLAM algorithm for simultaneous localization and mapping is used to simultaneously
determine an absolute coordinate system and a map of the surroundings, the map of the surroundings imaging the at least one extracted feature, and
determine an absolute pose of the movable part of the industrial robot, the absolute pose being a pose in the absolute coordinate system.

Furthermore, another aspect relates to an industrial robot,
comprising at least one imaging sensor, which is mounted on a movable part of the industrial robot, and
comprising a controller, which is configured to carry out the method using the industrial robot.

The advantages specified below need not necessarily be obtained by the subject matter of the independent patent claims. Further, these may also be advantages which are only obtained by individual embodiments, variants or developments.

By way of example, imaging sensors are applied to the links of the industrial robot, said sensors being able to capture features present in the surroundings and the measurement values of said sensors being suitable for determining the pose of the imaging sensor, and hence the pose of the robot link carrying the imaging sensor, in relation to the surroundings in absolute terms.

To this end, the surroundings has features that can be identified by the sensors, and the position and orientation of which features relative to the sensors can be at least partly established. These can be both features specifically applied for the purposes of determining the position and orientation of the robot and features that are present in the surroundings in any case. The position and orientation of the features are determined by the industrial robot itself by using its sensors. The established absolute pose is a pose in an absolute, stationary coordinate system.

The method transfers the technique of simultaneous localization (i.e., determination of position and orientation) and of construction of a map of features of the surroundings from mobile robotics to the orientation of a stationary industrial robot. Here, the absolute coordinate system is established, the position and orientation of features of the surroundings in relation to the absolute coordinate system are determined and the position and orientation of movable parts of the industrial robot in relation to the absolute coordinate system are calculated, preferably in simultaneous fashion. This is based on the measurement of sensors which are applied to the movable parts. Advantageously, sensors that establish the positions of the joints are additionally also taken into account.

Embodiments or developments of the method may offer the advantage that an absolute position and orientation is established, even in the case of inaccurate or elastic industrial robots and in the case of different loads. Furthermore, it is possible to determine parameters in a model of the industrial robot and thus possibly improve the accuracy of the measurement of position and orientation, and the control of the industrial robot. Costs and equipping times can be reduced as a result of using features that are present in the surroundings in any case. The position and orientation of the features are determined by the industrial robot with the imaging sensors itself; external calibration apparatuses and specific calibration processes are no longer mandatory. Since absolute position and orientation are used in relation to the absolute coordinate system, it is possible for workpieces to be placed relative to the absolute coordinate system by a further agent (human or machine). To this end, it is possible to use the information about position and orientation of a few features in the surroundings.

The joints of the industrial robot may have linear axes and/or axes of rotation, for example. The last link in the kinematic system of an articulated arm robot with a serial kinematic system is a link which has a flange as a tool interface, for example. In the case of a delta robot with a parallel kinematic system, the last link is a work platform, for example.

By way of example, the imaging sensors can be assembled on the respective links or can be embedded in the latter.

By way of example, the absolute coordinate system consists of rectangular coordinate axes, which are fixed and absolute in space. The origin thereof is preferably fixed to a single point in space. The absolute coordinate system does not change or move in relation to the industrial robot, but the links of the industrial robot can be moved within the absolute coordinate system in a manner corresponding to the kinematic system.

For the purposes of creating a map, there may be, where necessary, a prescription for the industrial robot as to the criteria to be used to select the absolute coordinate system thereof, for example in correspondence with a corner of the room or with the floor.

According to one embodiment, a method is developed
in which determining the map of the surroundings is a statistical estimate and
in which the absolute pose is modeled as a probability density function.

The absolute pose need not be determined in all coordinates. It may also have an unsharpness and may be described in probabilistic fashion, for example as a probability density function like in this embodiment.

According to one embodiment, a method is developed
in which the SLAM algorithm iteratively carries out a Kalman filter algorithm, an extended Kalman filter algorithm, an unscented Kalman filter algorithm or a particle filter algorithm.

Iterative methods are based on iterative prediction and correction.

According to one embodiment, a method is developed
in which the SLAM algorithm is based on a factor graph algorithm, in particular a GTSAM algorithm.

According to one embodiment, a method is developed
in which the industrial robot repeatedly carries out defined movements, in particular translations or rotations of a link, and
in which the features of the surroundings are extracted during and/or after each movement from the signals of the at least one imaging sensor.

According to one embodiment, a method is developed
in which the industrial robot outputs the absolute coordinate system.

To this end, the industrial robot can drive to points in the absolute coordinate system and output the coordinates thereof in parallel, for example. This allows a transformation to be set between the absolute coordinate system determined by the industrial robot and an application coordinate system.

According to one embodiment, a method is developed
in which the at least one imaging sensor is mounted on a carrier link, and
in which the absolute pose for the carrier link is determined.

According to one embodiment, a method is developed
in which the features of the surroundings are extracted from signals of a plurality of imaging sensors, which are mounted on the carrier link, the imaging sensors being aligned in different directions.

The different directions are advantageous since cameras are able to determine a lateral offset of a feature better than a distance or rotation of the feature.

According to one embodiment, a method is developed
in which the carrier link is one of a plurality of links of the industrial robot, the links being movable as per a kinematic system.

According to one embodiment, a method is developed
in which drives of the links are actuated for setting a pose, predetermined in an absolute coordinate system, of a tool interface of the industrial robot.

This provides absolute positioning of the tool interface in the absolute coordinate system. Setting the predetermined pose can always also contain the same orientation or, for example, only be implemented in two dimensions or one dimension, for example if the respective kinematic system only allows this for constructional reasons and therefore restricts the setting options.

The continuously established absolute pose is used to bring the tool interface of the industrial robot into the predetermined pose. The latter is identical to a desired pose of an effector, which is mounted on the tool interface, or it can be calculated therefrom using a simple transformation.

According to one embodiment, a method is developed
in which the established absolute pose is taken into account when setting the predetermined pose.

According to one embodiment, a method is developed
in which signals of an internal sensor system of the industrial robot are taken into account when setting the predetermined pose.

The internal sensor system preferably relates to sensors that establish the positions of joints or links of the industrial robot.

According to one embodiment, a method is developed
in which parameters of a movement model, which is based on a kinematic system of the industrial robot, are calculated depending on the absolute pose and/or signals of an internal sensor system of the industrial robot.

Here, the parameters in the movement model of the industrial robot are determined, which is equivalent to a running calibration.

According to one embodiment, a method is developed
in which the predetermined pose is set on the basis of the movement model.

According to one embodiment, a method is developed
in which the features of the surroundings are extracted from signals of a plurality of imaging sensors, which are mounted on a plurality of links, in particular all links, of the industrial robot,
in which absolute poses are determined for the respective links on the basis of the extracted features, the absolute poses being poses in the absolute coordinate system, and
in which the absolute poses are used for calculating parameters of a movement model and/or for setting a predetermined pose of a tool interface of the industrial robot in the absolute coordinate system.

Where necessary, the last link in the kinematic system of the industrial robot may be excluded and not carry an imaging sensor so as not to impede the effector or use of the industrial robot.

A computer program product is stored on the computer-readable data medium, said computer program carrying out the method when it is executed on a processor. The computer program product is executed on a processor and carries out the method in the process. A computer program product comprising a computer readable hardware storage device having computer readable program code stored therein, said program code executable by a processor of a computer system to implement a method.

### BRIEF DESCRIPTION

Some of the embodiments will be described in detail, with reference to the following figures, wherein like designations denote like members, wherein”

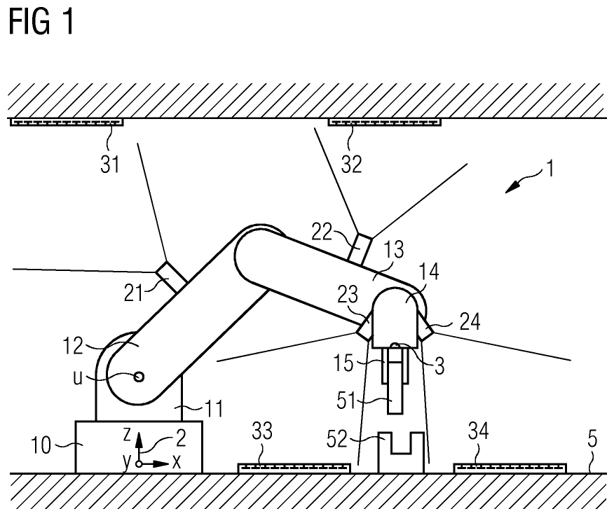

FIG. 1 shows an industrial robot having four cameras;

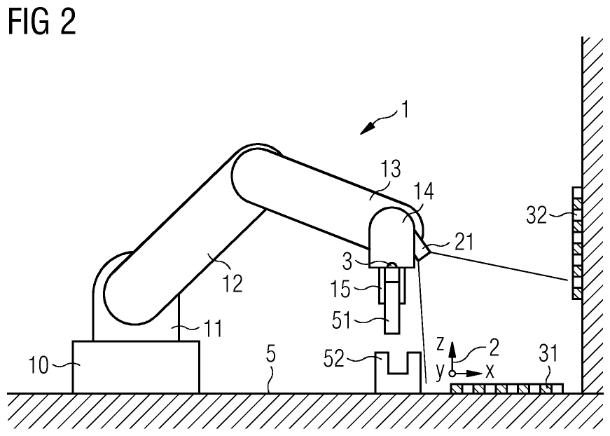

FIG. 2 shows an industrial robot having a camera on a last link; and

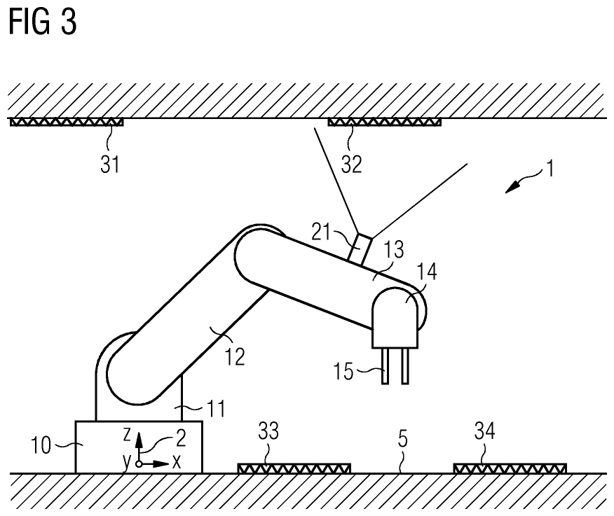

FIG. 3 shows an industrial robot having a camera on a third link.

### DETAILED DESCRIPTION

FIG. 1 shows an industrial robot 1, which is embodied as an articulated arm robot with four links. A first link 11 is mounted on a stationary base 10. In a serial kinematic system of the industrial robot 1, this is followed by a second link 12, on which a first camera 21 is mounted, a third link 13, on which a second camera 22 is mounted, and a last link 14, on which a third camera 23 and fourth camera 24 are mounted, said latter two cameras being aligned in different directions. An effector 15, a gripper in this case, is also mounted on the last link 14, said effector being intended to insert a first workpiece 51 into a second workpiece 52. By way of example, the last link 14 has a flange plate with a center 3, on which the effector 15 is mounted. Here, the flange plate forms a tool interface, on which an interchangeable tool receptacle for different tools may also be mounted.

In principle, the cameras 21, 22, 23, 24 can be distributed as desired on one or more links, in particular on all links, too. A plurality of cameras mounted on one and same carrier link are preferably aligned in different directions.

Depending on field of view, the cameras 21, 22, 23, 24 record a first feature 31, a second feature 32, a third feature 33 and a fourth feature 34 of a surroundings. By way of example, the features are rotationally-invariant ARToolKit markers, QR codes or checkerboard patterns. However, the features may also be structures present in the surroundings in any case, it being possible to extract said structures as SIFT or SURF features using suitable algorithms.

Below, the term “absolute positioning” should be understood to mean driving a defined point on the industrial robot 1 to a position provided in an absolute coordinate system 2. In the example shown in FIG. 1, the defined point on the industrial robot 1 is the center 3 of the flange plate or the outermost point on an axis of rotation of the last link 14, for example; thus, as a rule, it is the tool interface or a point on the effector 15 itself.

Here, absolute positioning may also contain the setting of an orientation. Thus, in this case, an absolute pose, i.e., a position and orientation of the tool interface or of the effector 15, is set in the absolute coordinate system 2. Here, the pose to be set can be predetermined as a predetermined pose and can be calculated, for example, from CAD data of the second workpiece 52 for a number of work steps if the position of the second workpiece 52 in the absolute coordinate system is known.

As a stationary coordinate system, the absolute coordinate system 2 is related, for example, to the stationary base 10 of the industrial robot 1 or to a surroundings, e.g., a work region, a cage around the industrial robot 1, cartridges, shelves, etc.

If the absolute coordinate system 2 is related to the industrial robot 1, it depends on the kinematic system of the industrial robot 1, for example as shown in FIG. 1. In the exemplary embodiment shown in FIG. 1, the first degree of freedom of movement of the first link 11 is a substantially vertical axis of rotation 4. Here, this axis of rotation 4 can be used, for example, as z-axis of the absolute coordinate system 2, which is set in such a way that the rotary encoder of this axis specifies 0°. The x-axis of the absolute coordinate system 2 is chosen to be orthogonal to the second link 12, i.e., to the axis of rotation of the second degree of freedom, and orthogonal to the z-axis. If this axis of rotation of the second degree of freedom is referred to as u, then the x-axis is the normalized cross product x=(u×z)/∥u×z∥. Then, the y-axis is the cross product of z and x, i.e., z×x. By way of example, the intersection of the z-axis with a workbench 5 is selected for the origin of the absolute coordinate system 2. So that the latter is visible, the third feature 33 and the fourth feature 34 are attached to the workbench 5, said third and fourth features being seen in the cameras of the industrial robot 1.

This is an exemplary embodiment for a robot-centric absolute coordinate system 2; i.e., the essential features for determining the absolute coordinate system 2 are found in the robot kinematic system. However, the essential features for determining the absolute coordinate system 2 may also be found in the surroundings, as shown in FIG. 2, and they may occur there naturally or they may be specifically installed, i.e., they may have been attached there for reasons other than for the purpose of establishing the absolute coordinate system 2 (as workbench, cartridge, protective grid, etc.), or they are articles or structures or patterns that can be captured particularly well by the cameras and that were therefore attached in the surroundings. By way of example, within the scope of the latter meaning, the workbench 5 can be provided with a checkerboard pattern that is captured particularly well by cameras. Then, this workbench 5 will fix the xy-plane and the origin is fixed using a further pattern, for example using an arrow that points to a corner in the checkerboard.

In one variant, the industrial robot 1 outputs the absolute coordinate system 2 to a user or further machines. To this end, the industrial robot 1 drives, for example, to specific points in the absolute coordinate system 2, e.g., (1,1,0), (1,−1,0), (−1,1,0), (−1,−1,0), (1,1,1), (1,−1,1), (−1,1,1), (−1,−1,1). Alternatively, a user can manually drive to characteristic positions (for example, a point on a shelf) using the industrial robot 1 and can in this respect receive the absolute coordinates as a speech output, a digital data record or the like. In the process, the industrial robot 1 communicates correct absolute coordinates, which observe the rules of the geometry in 3D. If two points A and B are specified and physically driven to in the workspace, the Euclidean distance between the points must correspond in calculation, ∥A−B∥, and in measurement. A corresponding statement also applies to angles.

According to one application scenario, the industrial robot 1 assembles a motor which has a large number of variants. Maybe the construction of the motor was also adapted and the industrial robot 1 sees this motor for the first time, even though it has knowledge of the CAD plans. The positions that have to be driven to in sequence for assembly purposes have not been driven to in advance, which is why it is not possible to use relative positioning with a high repetition accuracy. Instead, absolute positioning with sufficient accuracy is necessary. In relation to FIG. 1, the motor is, for example, the second workpiece 52, into which the first workpiece 51 should be inserted. To this end, it is necessary for the position of the second workpiece 52 to be accurately known in the absolute coordinate system 2 of the industrial robot 1. Preferably, the second workpiece 52 is inserted into a holder that is sufficiently accurately defined by means of centering pins to this end, whereupon all parts are subsequently assembled on the growing motor. Then, the position of the points in the absolute coordinate system 2, to which the industrial robot 1 must drive new workpieces, follows from suitable CAD data and the initial position of the second workpiece 52. The necessary orientation of the industrial robot 1 is implemented in the same way.

Thus, the industrial robot 1 must be able to adopt the respectively necessary accurate position and orientation with the effector 15, and to this end it moves its motors. Its so-called internal sensor system usually captures the position of its joints. Mathematical fundamentals for calculating the position and orientation from these sensor measurements are known from the prior art, for example from the document “Roboterkalibrierung” [robot calibration], obtainable via the Internet on Jul. 5, 2016 from https://de.wikipedia.org/wiki/Roboterkalibrierung. Following the notation from this document, the position and orientation y can be described as a function f of the joint positions x and several further parameters p that determine the function f more closely:

f:(x,p)→y.

Here, x is measured by way of sensors of the internal sensor system and it is consequently afflicted by errors. The absolute positioning established in this manner is not accurate enough for numerous applications. Firstly, the parameters p are not accurately known. This should improve the calibration in which the parameters are modified in such a way that, for a number of physically measured points in absolute coordinates, the sum of the square deviations of the modeled point and measured point is minimized.

However, such a calibration has its limits. Firstly, it is difficult to measure the points to be driven to physically. Secondly, the model of industrial robot 1 is often incomplete as it does not map all properties on which the position and orientation of the industrial robot 1 (e.g., of the center 3 of its flange plate) depend. This includes properties of the gears, the elasticities thereof or the hysteresis behavior thereof, or elasticities of the links, temperature effects, inaccuracies of the internal sensor system, etc. Using appropriate outlay, it is possible to construct and calibrate more accurate models, i.e., more complete models.

In order to obtain a high absolute accuracy, the position and orientation of the industrial robot 1 can be derived in model-based fashion, firstly, from measurements of the joint positions. Secondly, the position and orientation can also be measured directly on the effector 15 or at the center 3 of the flange plate. By way of example, a measurement body can be applied between the flange and the effector 15 to this end, said measuring body being captured by an external sensor in the surroundings. The accurate position is established here both from the measurements of the joint positions and from the localization of the measurement body and the industrial robot 1 is accordingly regulated into this position. However, such measurement bodies are voluminous and may be in the way in some tasks.

The first camera 21, second camera 22, third camera 23 and fourth camera 24, which are distributed among the different links of the industrial robot 1 in FIG. 1, are smaller and more cost-effective than such measurement bodies and supply further measurements, from which the accurate position of the effector 15 can be determined.

Here, the third camera 23 and the fourth camera 24 are mounted directly in the vicinity of the effector 15 on the last link 14, i.e., in a similar position to the measurement body already explained above. Instead of viewing such a measurement body from the outside, the third camera 23 and fourth camera 24 record the third feature 33 and the fourth feature 34 of the surroundings from the vantage of the industrial robot 1.

A plurality of examples of how the absolute coordinate system 2, a map of the surroundings and an absolute pose of the industrial robot 1 can be determined at the same time by means of a simultaneous localization and mapping are given below. Here, reference is made to FIG. 2 and the explanations made above. By way of example, the map of the surroundings is a statistical estimate, while the absolute pose can be modeled well as a probability density function.

FIG. 2 shows, once again, an industrial robot 1, which is embodied as an articulated arm robot with four links. Naturally, the industrial robot 1 in this exemplary embodiment, just as in all other exemplary embodiments, may also be embodied with more than or fewer than four links. In principle, any kinematic system comes into question for the industrial robot 1, for example a serial kinematic system consisting of axes of rotation (R), translational axes (T) or a combination of these two types. By way of example the serial kinematic system can be an RRR/RRR, RTR/RRR, TRR/RRR, RRT/RRR, RTT/RRR, RT/RRR or TR/RRR kinematic system of a robot with two or three principal axes and three wrists. Furthermore, the kinematic system of the industrial robot 1 may also be a parallel kinematic system.

In the individual case shown in FIG. 2, a first link 11 of the industrial robot 1 is mounted on a stationary base 10. This is followed, in a serial kinematic system of the industrial robot 1, by a second link 12, a third link 13 and a last link 14, on which a first camera 21 is mounted. The last link 14 has a flange plate with a center 3, on which an effector 15, in this case a gripper, is mounted, said effector being intended to insert a first workpiece 51 into a second workpiece 52.

The goal of the present exemplary embodiment is to determine an absolute pose of a movable part of the industrial robot 1, the absolute pose being a pose in an absolute coordinate system 2, which was already explained above and which is plotted in a new variant in FIG. 2. By way of example, the movable part is the last link 14, the first camera 21 or the effector 15. Corresponding coordinates can easily be converted into one another since all corresponding components are assembled in rigid fashion in relation to one another on the last link 14.

FIG. 2 shows a case in which the absolute pose is calculated for the last link 14, the first camera 21 or the effector 15 since the first camera 21 is mounted on the last link 14. However, in principle, in relation to the explanations made below and as shown in FIG. 1 the first camera 21 could also be mounted on the second link 12 or on the third link 13. In this case, the absolute pose would be calculated for the second link 12 or the third link 13, which is likewise advantageous for improving the accuracy of the calculations in the industrial robot 1 for the absolute positioning.

In FIG. 2, the base 10 of the industrial robot 1 is once again mounted on a workbench 5, which has a checkerboard painted thereon as a first feature 31, said checkerboard lying in the field-of-view of the first camera 21. The edge length of the fields of the checkerboard is known and the first camera 21 is calibrated. Furthermore, a kinematic model of the industrial robot 1 is available. Sensors of an internal sensor system of the industrial robot 1 record its joint positions but are not accurate enough for absolute positioning in this case.

In this case, the map of the surroundings only contains the “checkerboard” reference pattern with its intrinsic properties (right-angled, edge length of the fields) and its position and orientation in 3D. In the present scenario, the map is constructed in 3D because the industrial robot 1 can move freely in 3D. However, depending on the degrees of freedom of the industrial robot 1, a map in 2D may also be sufficient.

In accordance with FIG. 2, the workbench 5 predetermines an xy-plane of an absolute coordinate system 2 since this simplifies the communication of the absolute coordinate system 2 with the outside world. To this end, the checkerboard pattern of the first feature 31 defines the xy-plane of the absolute coordinate system. If the x-axis and the y-axis are painted onto the checkerboard, the complete mapping has already been completed.

Localizing the effector 15 is now performed by means of the first camera 21. In the structure shown in FIG. 1, position and orientation of the first feature 31 relative to the first camera 21 can be established from the camera image. By way of example, the camera image is predicted using assumptions about position and orientation and this prediction is compared to the actual camera image. Then, position and orientation are modified until both correspond. Since, in this case, the pose is established relative to the checkerboard of the first feature 1, which also defines the absolute coordinate system 2, it is available in absolute coordinates.

Within the scope of image processing, the distance to the first feature 31 and the orientation, in particular, can only be determined inaccurately under certain circumstances. In order to improve this accuracy, a second checkerboard is mounted to a wall as a second feature 32, in a manner approximately perpendicular to the first feature 31. The position and orientation of the second feature 32 are determined in the next step. By way of example, the last link 14 is rotated to this end until the second feature 32 becomes visible in the camera image of the first camera 21. A rotation about a fixed angle range (e.g., 60° or 90°) can be repeated very accurately using conventional industrial robots since the repetition accuracy exceeds the absolute accuracy.

The position and orientation of the second feature 32 is determined as set forth below. First, the position and orientation of the first camera 21 are established relative to the first feature 31. Subsequently, the last link 14 is rotated. The position and orientation of the first camera 21 after the rotation are calculated in a third step. Subsequently, the position and orientation of the second feature 32 are determined in relation to the first camera 21 in a fourth step. As a result, the position and orientation of the second feature 32 are established in the absolute coordinate system 2, i.e., in relation to the first feature 31.

This can be repeated for many different positions and orientations of the industrial robot 1, with a different position and orientation of the second feature 32 being calculated in each case, even though these should be constant. Therefore, the parameters of the camera movement and the position and orientation are set in such a way that the variation of position and orientation of the second feature 32 is minimized, i.e., the map is improved. At the same time, this also improves the estimate for the absolute pose of the industrial robot 1 (for the first camera 21, in this case). The absolute pose of the end effector 15 can also be calculated directly from the absolute pose of the first camera 21 as both are mounted on the last link 14.

The position of the absolute coordinate system 2 is predetermined by the first feature 31 in the exemplary embodiment explained above. Here, the first feature 31 is known a priori. To this end, the first feature 31 and, where necessary, the second feature 32 can also be measured accurately a priori using suitable sensors.

FIG. 3 shows a further industrial robot 1, which is embodied as an articulated arm robot having four links. As explained above, any other kinematic system is also possible, for example that of a six- or seven-axis articulated arm robot. In the exemplary embodiment of FIG. 3, the absolute coordinate system 2 once again is selected as shown in FIG. 1, wherein the z-axis of the absolute coordinate system 2 is derived from the first link 11, i.e., the first axis of rotation of the industrial robot 1, as was explained in the context of FIG. 1. A first feature 31, a second feature 32, a third feature 33 and a fourth feature 34, which are known to the industrial robot 1 a priori, are situated in the field of view of the industrial robot 1. Here, the field of view of the industrial robot 1 describes the coverage of the fields of view of a first camera 21 for all possible camera positions. By way of example, the features are rotationally invariant ARToolKit markers, QR codes or checkerboard patterns. However, the features can also be structures that are present in the surroundings in any case, which can be extracted as SIFT or SURF features using suitable algorithms.

In FIG. 3, the first camera 21 is mounted on the third link 13. This only serves for elucidating the variety of possible embodiments. Naturally, the camera 21 may also be mounted on any other one of the links 11, 12 and 14.

The first camera 21 is moved around on the third link 13 for construction of the map and simultaneous localization, as a result of which the features 31, 32, 33, 34 are captured. Here, these are defined movements, in particular translations or rotations, of a link. Here, information about the position and orientation of the first camera 21 can be calculated on the basis of the robot kinematic system. If one of the features 31, 32, 33, 34 is visible in the camera image, an estimate of the position and orientation of the feature in the camera coordinate system is consequently obtained and, via the kinematic system, this is obtained in absolute coordinates, too. With the knowledge that the position and orientation of the features 31, 32, 33, 34 are constant in absolute coordinates, it is possible to minimize the uncertainty about this position and orientation. At the same time, the estimates of the parameters of the kinematic system can also be optimized in the process. Once position and orientation of the features 31, 32, 33, 34 were finally accurately determined over many measurements, it is also possible to accurately determine the position and orientation of the first camera 21 from the images of the features 31, 32, 33, 34 (to be precise, very much more accurately than from only the position of the joints and the kinematic model). However, it is not necessary to wait for the completion of the setup of the industrial robot 1 in order to use the improved estimate of position and orientation of the features 31, 32, 33, 34 for the purposes of localizing the third camera 23 the estimate can also be used immediately.

The SLAM algorithm used to this end is sufficiently well known from the prior art. Below, a suitable exemplary embodiment of the SLAM algorithm is explained still with reference to FIG. 3.

Let cam(k) be the position and orientation of the first camera 21 in the absolute coordinate system 2 at a time k; further, let mᵢ be the position and orientation of the i-th feature 31, 32, 33, 34 in the absolute coordinate system 2. These variables should be estimated and, together, form the state vector of the entire system,

(cam(1),cam(2),cam(K),m₁, . . . ,mₘ).

To this end, joint positions x₁, . . . , x_{K} and sightings of the features 31, 32, 33, 34 are available as measurements. A measurement of the camera position cam(i) with a certain reliability follows from a joint position xᵢ. This is modeled as a probability density distribution for position and orientation. Here, the assumption is made that the mean error is 0; i.e., the kinematic system is calibrated. The calculation still works even if no high-quality calibration is present as only the covariance for cam(i) is increased accordingly.

Under the assumption that the feature i is seen by the first camera 21 at the time k, the position and orientation of the feature i are denoted as s(k, i) in camera coordinates. Since the features 31, 32, 33, 34 have a constant position and orientation, the composition of the position and orientation of the first camera 21 in absolute coordinates and the position and orientation of the respective feature 31, 32, 33, 34 in camera coordinates must be constant. This is achieved by virtue of having compensated an error that may have occurred. To this end, cam(k)+errorc(k) is used as first part of the composition and s(k, i)+errors(k, i) is used the second part of the composition. These errors emerge if a value (as an optimization variable) is inserted for cam(k) and mᵢ. They depend on the size of the distance between the value of the optimization variables and the measurement value and on the covariances assumed for the measurements. The camera positions and feature positions are selected in such a way that the entire error is minimal. Here, other camera positions than those determined from the kinematic system on its own are calculated; i.e., the features have a clear influence. The feature positions are also determined more accurately than from a single sighting.

Here, the map is improved at the same time and the position is determined, as is already known for other applications in the case of algorithms for simultaneous location and mapping (SLAM) from the prior art. Factor graph algorithms such as the GTSAM algorithm provide an expedient implementation of this approach; the latter is explained in great detail in the document “Factor Graphs and GTSAM: A Hands-on Introduction”, Georgia Institute of Technology, Center for Robotics and Intelligent Machines, CP&R Technical Report, 2012, obtainable via the Internet on Jul. 6, 2016 from http://hdl.handle.net/1853/45226.

A similar accuracy can also be obtained for the SLAM algorithm if an optimization is not carried out simultaneously over all measurements but if each measurement is taken into account as soon as it is performed. The above-described optimization of the system state (localization and mapping) is therefore performed iteratively. Algorithms suitable to this end are, for example, known as Kalman filter, extended Kalman filter, unscented Kalman filter or particle filter from S. Thrun, W. Burgard, and D. Fox, Probabilistic Robotics, MIT press, 2005, pages 65-71, 96-102 and 309-317.

The use of a single camera was explained in the last exemplary embodiments. This can be generalized. With reference again being made to FIG. 1, an exemplary embodiment for the use of a plurality of cameras 21, 22, 23, 24 on different links 11, 12, 13, 14 of the industrial robot 1 is explained in the following text. For this exemplary embodiment, the industrial robot 1 is generalized in relation to the representation in FIG. 1 and it is modeled in greater detail as a robot with six moving links g₁, . . . , g₆.

Instead of only the position and orientation of one of the links, for example of the last link g₆, being included, the position and orientation of each link on which a camera is mounted is now included in the state model. The pose of the respective link can be converted into a pose of the respective camera by a transformation of a coordinate system of the respective link. These are further parameters which likewise have to be determined more accurately by calibration. The coordinate system of the respective link is selected in accordance with the standard model by Denavit and Hartenberg; see the document “Denavit-Hartenberg-Transformation”, obtainable via the Internet on Jul. 6, 2016 from https://de.wikipedia.org/wiki/Denavit-Hartenberg-Transformation.

The joint positions now are no longer included overall in the calculation; instead, the relative position and orientation between two robot links which carry cameras are calculated, while interposed links do not carry cameras. Otherwise, the calculation corresponds to the preceding exemplary embodiments: the errors of the measurements are modeled and minimized just like in the preceding case, all robot links are localized simultaneously, and a plurality of links or cameras can by all means see the same features. Here, too, the optimization can be carried out both simultaneously over all observations and iteratively.

The last exemplary embodiments explained the use of features, known a priori, in the surroundings. Special optical markers, in which the possible positions and orientations of the camera relative to the marker can be established best, are suitable to this end. This corresponds to a concentrated probability density distribution. However, the following explains how other features can be used in the exemplary embodiments already described above.

By way of example, a poster, on which a point can be determined accurately by image processing methods and on which said point can be identified again, may be present in the surroundings as a feature instead of a checkerboard. Such image features are known as SIFT features or SURF features, for example; see the document “Scale-invariant feature transform”, obtainable from the Internet on Jul. 6, 2016 via https://en.wikipedia.org/wiki/Scale-invariant_feature_transform.

In such a case, the determination of that distance is very inaccurate, and two of the three rotational parameters are also very inaccurate. However, this uncertainty can also be modeled, once again, as a probability density distribution and the accuracy of the overall estimate can be established like in the preceding example. Thus, poorer information is available from individual measurements, but this can be compensated by more independent measurements.

Cameras as imaging sensors were explained in the preceding exemplary embodiments because there is a tendency here toward miniaturization and reduced costs with, at the same time, an increasing capability. However, other imaging sensors can also be used in the respective exemplary embodiments in place of the cameras since the principles described are also valid for other sensors. Thus, in addition to 2D cameras, 3D cameras, infrared cameras, structured light sensors, ultrasonic sensors and laser scanners are also suitable as imaging sensors.

Furthermore, instead of the cameras specified in the preceding exemplary embodiments, use can also be made of multi-plane laser scanners, which produce a dense point cloud, as imaging sensors. As a rule, such a point cloud contains characteristic structures that can be used as features for localization and mapping. A laser scanner with one scanning plane also can be used in this case if the surroundings have sufficiently many characteristic structures. In this case, it may be necessary to carry out specific movements for the purposes of improved localization and mapping.

Furthermore, active features, e.g., in the form of light sources, can also be attached in the surroundings. As explained above, it is helpful to provide the absolute position of these markers as a priori information, although this is not mandatory. Here too, a high absolute accuracy of the industrial robot can be achieved by simultaneous localization and mapping.

A possible implementation of one or more of the exemplary embodiments described above consists in an industrial robot having a controller, which carries out the appropriate calculations. To this end, the controller may have an electronic memory, evaluate signals of an internal sensor system of the industrial robot and of the imaging sensors and actuate drives of the industrial robot. Here, the controller may also perform closed-loop control by virtue of continuously establishing a current absolute pose from the camera images and the internal sensor system and adapting the latter until a predetermined pose with a predetermined accuracy is set.

Although the invention has been illustrated and described in greater detail with reference to the_preferred_exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for orienting an industrial robot comprising:
extracting at least one feature of a surroundings from signals of at least one imaging sensor, which is mounted on a movable part of the industrial robot, before, while or after the industrial robot carries out movements; and
utilizing a SLAM algorithm for simultaneous localization and mapping to simultaneously: (i) determine an absolute coordinate system and a map of the surroundings, the map of the surroundings imaging the at least one feature and (ii) determine an absolute pose of the movable part of the industrial robot, the absolute pose being a pose in the absolute coordinate system.

2. The method as claimed in claim 1, wherein determining the map of the surroundings is a statistical estimate and the absolute pose is modeled as a probability density function.

3. The method as claimed in claim 2, wherein the SLAM algorithm iteratively carries out a Kalman filter algorithm, an extended Kalman filter algorithm, an unscented Kalman filter algorithm, or a particle filter algorithm.

4. The method as claimed in claim 1, wherein the SLAM algorithm is based on a factor graph algorithm.

5. The method as claimed in claim 1, wherein the industrial robot repeatedly carries out defined movements, the defined movements being translations or rotations of a link, further wherein the at least one feature of the surroundings is extracted during and/or after each movement from the signals of the at least one imaging sensor.

6. The method as claimed in claim 1, wherein the industrial robot outputs the absolute coordinate system.

7. The method as claimed in claim 1, wherein the at least one imaging sensor is mounted on a carrier link, and the absolute pose for the carrier link is determined.

8. The method as claimed in claim 7, wherein the at least one feature of the surroundings is extracted from signals of a plurality of imaging sensors which are mounted on the carrier link, the plurality of imaging sensors being aligned in different directions.

9. The method as claimed in claim 7, wherein the carrier link is one of a plurality of links of the industrial robot the plurality of links being movable as per a kinematic system.

10. The method as claimed in claim 9, wherein drives of the plurality of links are actuated for setting a pose, predetermined in an absolute coordinate system, of a tool interface of the industrial robot.

11. The method as claimed in claim 10, wherein the established absolute pose is taken into account when setting the predetermined pose.

12. The method as claimed in claim 10, wherein signals of an internal sensor system of the industrial robot are taken into account when setting the predetermined pose.

13. The method as claimed in claim 1, wherein parameters of a movement model, which is based on a kinematic system of the industrial robot are calculated depending on the absolute pose and/or signals of an internal sensor system of the industrial robot.

14. The method as claimed in claims 10, wherein the predetermined pose is set on the basis of the movement model.

15. The method as claimed in claim 1, wherein the at least one feature of the surroundings is extracted from signals of a plurality of imaging sensors, which are mounted on a plurality of links of the industrial robot, wherein absolute poses are determined for the respective links on the basis of the at least one feature the absolute poses being poses in the absolute coordinate system, further wherein the absolute poses are used for calculating parameters of a movement model and/or for setting a predetermined pose of a tool interface of the industrial robot in the absolute coordinate system.

16. A computer-readable data medium, stored on which there is a computer program which carries out the method as claimed in claim 1 when executed on a processor.

17. A computer program product, comprising a computer readable hardware storage device having computer readable program code stored therein, said program code executable by a processor of a computer system to implement a method according to claim 1.

18. An industrial robot, comprising:
at least one imaging sensor which is mounted on a movable part of the industrial robot; and
a controller, which is configured to carry out the method as claimed in claim 1 using the industrial robot.
